(19) United States
(12) Patent Application Publication
(10) Pub. No.: US 2014/0364082 A1
(43) Pub. Date: Dec. 11, 2014

(54) System And Method For Routing A Message, And A Computer Program Product

(71) Applicant: Dynmark International Ltd., Cheltenham (GB)

(72) Inventors: David Baddeley, Cheltenham (GB); Paul Putman, Cheltenham (GB)

(21) Appl. No.: 13/910,301

(22) Filed: Jun. 5, 2013

(51) Int. Cl. H04M 15/00; H04W 40/02; H04W 4/14

(52) U.S. Cl. CPC H04M 15/8061; H04W 4/14; H04W 40/02
USPC 455/406; 455/466

(57) ABSTRACT

A computer-implemented method for routing a message to a recipient user equipment device, comprising receiving data representing the message at a messaging application server, selecting a delivery channel for the message from multiple delivery channels on the basis of a set of delivery preferences associated with the recipient device, and forwarding the message using the selected delivery channel.

### TECHNICAL FIELD

The present disclosure relates to the field of communications, and more particularly, although not exclusively, to the field of message routing using a telecommunication and/or data network.

### BACKGROUND

In a telecommunication network or system, messaging service components can be used to allow messages to be exchanged between devices that are part of or otherwise using the network. Such messaging services include for example SMS (short messaging service) and MMS (multimedia messaging service)—the former enabling the transfer of text-based messages between devices, the latter providing a somewhat richer experience inasmuch as messages including multimedia content, such as images, can be exchanged. The use of the telecommunication network when using these messaging components results in a cost to a user of a device from the service provider as a result of the necessary use of network resources to enable the message and any other associated content to traverse the network infrastructure between devices.

Recently, options for message-based communications have increased with the provision of a number of low-cost and free alternatives to the above-noted services. The alternatives are typically referred to as over-the-top (OTT) services, as they enable devices to exchange messages without recourse to the traditional methods of delivery associated with standard messaging services—that is, they operate ‘over-the-top’ of the telecommunication network and operate using a provider-independent platform. An OTT application will typically be provided by way of application (app) on a user device or as a service that enables communication over the Internet or using a telecommunication data plan or connection associated with the device, and which therefore bypasses traditional distribution of such content.

Broadly speaking, there are currently two different OTT alternatives that have emerged: operating system (OS) specific systems and third-party applications, which are typically cross-platform. Both sets of applications enable a richer user experience, but at a reduced (or zero) price compared with traditional messaging services.

### SUMMARY OF THE INVENTION

According to an aspect, there is provided a computer-implemented method for routing a message to a recipient user equipment device, comprising receiving data representing the message at a messaging application server, selecting a delivery channel for the message from multiple delivery channels on the basis of a set of delivery preferences associated with the recipient device, and forwarding the message using the selected delivery channel.

Selecting a delivery channel can include determining a notional cost to deliver the message using respective ones of the multiple delivery channels. A delivery channel can be selected from one of an SMS delivery channel for a telecommunication network and a data channel. A data channel can be selected in preference to an SMS delivery channel. A read receipt can be received from the recipient device at the application server for a forwarded message over a data channel, and the preferences associated with the device can be updated on the basis of the received receipt. Updating the preferences can include determining an elapsed period of time between forwarding of the message and receipt of the read receipt. On the first use of a data delivery channel an optional opt in message can be sent prior to forwarding the actual message seeking permission to use the data channel for messaging. The opt in mechanism is configurable per data channel. If no opt in response is received within a defined time period it is assumed the user is not active on the data channel and the delivery channel selection process is repeated excluding the declined data channel.

A message can be forwarded over the selected delivery channel using an appropriate protocol e.g. the extensible messaging and presence protocol (XMPP). In an example, determining the identity of the device can include using metadata associated with the message to determine a contact number for the device. The set of preferences can be mapped to the identity of the device. The identity of a device can be determined using metadata from a message received at the application server from the recipient device. A device database stored on the application server can be augmented with details of the device including at least an identifier associated with the device. The message can be forwarded to multiple recipient user equipment devices.

According to an example, there is provided a system for routing a message to a recipient user equipment device, comprising a messaging application server to receive data representing the message, select a delivery channel for the message from multiple available delivery channels on the basis of a set of delivery preferences associated with the device, and forward the message using the selected delivery channel. The application server may be operable to select a delivery channel based, at least in part, on a notional cost associated with forwarding the message using respective ones of the multiple delivery channels. The application server may be operable to receive a read receipt from the recipient device for a forwarded message over a data channel, and classify a delivery channel for the device on the basis of the received receipt. The application server may be operable to use metadata associated with a message received by it from a device to determine an identifier for the device. The application server may be operable to use the metadata to determine if the device is a known device, and if not to augment a device database stored on the application server with details of the device including at least an identifier associated with the device.

According to an aspect, there is provided a computer program product, comprising a computer usable medium having computer readable program code embodied therein, said computer readable program code adapted to be executed to implement a method for routing a message to a recipient user equipment device as noted above.

### BRIEF DESCRIPTION OF THE DRAWINGS

Embodiments will now be described, by way of example only, with reference to the accompanying drawings, in which:

FIG. 1 is a schematic block diagram of a system according to an example;

FIG. 2 is a flowchart of a method according to an example; and

FIG. 3 is a schematic block diagram of an overview of a system according to an example.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

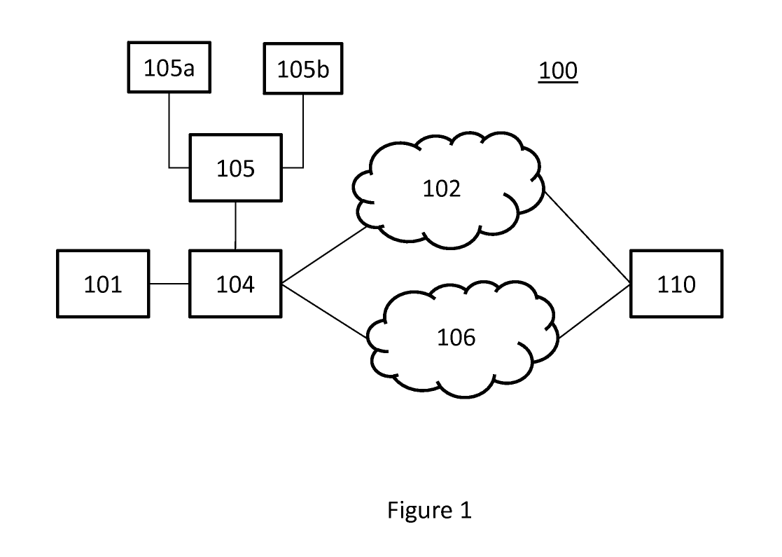

FIG. 1 is a schematic block diagram of a system according to an example. The system 100 includes a telecommunication carrier network 102, a messaging application server 104, a network 106 and a recipient user equipment device 110. Network 106 can include a networked system that includes several computer systems coupled together, such as a local area network (LAN) or wide area network (WAN) or the Internet for example. The messaging application server 104 is coupled to network 102 and 106.

Network 102 is a telecommunication network, such as a 3G network for example, capable of supporting voice and data transmission between multiple devices. A device used in the specification can be referred to as a device, terminal, mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various embodiments of the device can include a cellular phone, a smart phone having a wireless communication function, a personal digital assistant (PDA) having a wireless communication function, a wireless modem, a portable computer having a wireless communication function, a capturing device such as a digital camera having wireless communication function, a game device having a wireless communication function, a music storage and replay appliance having a wireless communication function, an Internet appliance enabling wireless Internet access and browsing, and terminals or a portable unit having combinations of the functions. Other alternatives are possible.

The messaging application server 104 receives data 105 representing a message to be forwarded. According to an example, data 105 can include message data 105a and a list of recipient devices 105b. For example, the data 105 can be provided by an individual or enterprise interested in relaying the message 105a to multiple recipients 105b. For example, the message could be a marketing message, which can include a URL or other marketing material such as embedded multimedia data for example. Alternatively, data 105 can include only message data. One or more recipients for the message can be provided or otherwise known on the application server 104.

Data 105 is received at server 104, and a delivery channel for the message is selected from multiple delivery channels. In an example, data can be provided to the server 104 using an upload tool or system. A list of recipients, such as 105b, for the message 105a includes data associated with one or more devices. For example, the data can be a globally unique identifier to enable a message to be routed to a device. The identifier can be a phone number associated with the device, a device IMSI, or any other such identifier for example. Each identifier, and thus each ultimate device, has a set of delivery preferences associated with it. According to an example, the delivery preferences specify the means by which a message can be received by the device, and in the event that multiple such delivery channels are permitted or otherwise allowable channels for a device, they can specify a preferred channel for the device. In an example, as a recipient is identified according to the identifier, the routing of a message is largely device independent. That is, a unique identifier can be migrated from device to device, such as when a user ports their number to a new phone for example. Accordingly, in an example, an identifier can be a device independent identifier that more broadly defines a recipient for a message, rather than identifying a specific device for a message. As such references herein to a ‘number’ should be taken to include reference to an identifier, which can include an identifier as described above.

A delivery channel can include a channel for delivery of an SMS or MMS message using the network 102, and can also include a channel in which a message is sent using an OTT service over network 106 for example, or alternatively, using a data plan of a device over network 102. For example, an OTT service can be used in which a message is sent using TCP/IP with data representing the message being sent over network 106, such as the internet if the device 110 is connected thereto, or being sent using a data plan of the device 110 using network 102. In the case that an OTT service is used, the cost to send the message to the device 110 will likely be considerably lower than the cost to send it using a carrier specific mechanism or channel.

Accordingly, intelligent routing of a message to a recipient or multiple recipients a delivery channel can be dynamically selected in order to maximise deliverability and minimise the costs associated with delivery of a message. Using a combination of the availability of a device as identified using a phone number for example on a delivery channel, the recipients channels preferences (opt in) and a cost of delivery on that channel, a method and system according to an example selects a cost effective and available or preferred delivery channel to route a message based on preference options set by a customer for example.

Messaging application server 104 can therefore forward a message for a recipient device 110 over a telecommunication network 102, and in an example, the device 100 can send a message for receipt at the server 104 via the network 102. That is, the messaging application server 104 is connected to network 102 to enable and provide global two way messaging.

In an example, a channel/connection/link can be made open via OTT network providers using for example the extensible messaging and presence protocol (XMPP), and messages can be sent and received in a similar way as those sent and received via SMS for example. OTT networks use different protocols than SMPP which is used for SMS. Therefore, to gain a connection to an OTT network, server 104:
1) Connects via an API to the network;
2) Creates an equivalent message using the protocol associated with the selected OTT data channel;
3) Creates an individual account within the OTT (if one does not already exist for the sender) network to correspond to the account information contained within the messaging application (104) (the customer name). In addition, the OTT network account may provide one or more of the following:
   a. Read receipts on—to track open rates and provide intelligence
   b. Account Status—to allow an enterprise to set their status
   c. Profile

It is also assumed that there will be multiple OTT networks available for a potential enterprise to contact an end number/device.

In an example, an enterprise can also have the choice to select:
the networks are available to them
the terms of priority when trying to contact a user via an opt in process, such as which network is preferred (typically, whichever network a user accepts during an opt in process for example, will be set as the default network to contact that user on).

Due to the sensitivity enterprises have based on user acceptance an opt in/out process can be provided. This can also form the proposition with OTT providers to ensure any communication received into their messaging application has been requested by the user removing the ability for spamming over OTT channels (a capability that is not manageable with the sending of SMS).

In an example, for a message to be sent via an OTT delivery channel in the first instance the user/device/number must opt in. An opt in process can be provided as follows:
1) A set of preferences can be provided that detail the way in which an enterprise wishes messages to be sent on its behalf. If within these preferences, an enterprise has elected to send via OTT, an opt in process is instigated;
2) Before a message can be sent the number/device/user is sent an opt in message notification if the number is live on the OTT network;
3) If the message cannot be sent, the message is stored until the preferred channel opt in process can be completed. If the preferred channel is SMS channel, the message will be sent immediately and not include the opt in process;
4) The opt in notification message is configurable by the enterprise;
5) The message contains the ability for users to send back a keyword or URL to click to respond, such as for example:
   a. Yes (opt in)
   b. No (do not opt in)
6) Opt in information can be provided for analytical purposes in connection with the device/number;
7) If no opt in response has been received within a pre-selected timeframe e.g. 24 hrs/48 hrs/12 hrs and so on, the system can send another opt in message to the number allowing a follow up message to be sent. Again this is configurable as to the amount of time given for a response. If no response is received from a second message the OTT channel will be considered “uninterested for that enterprise” and will select the next available channel;
8) If a positive response is received the enterprise can be taken to have received permission to send communications via an OTT application or service.

In order to opt out, the following process can be taken:
1) As a footer to all messages sent according to an example, there can be an option to opt out that is provided at the bottom for example. This can be a textual field for a ‘stop’ response, or a click through to enable a user to opt out via a webpage for example;
2) An opt out message can be configured as desired by the enterprise as in the case of the opt in message;
3) If the number chooses to opt out by clicking the link or responding, the number is added to an opt out list of the messaging application server 104.

User behaviour can change over time, and thus where a user may use one OTT channel at one point in time, they may cease to use that channel in the future. The use of a particular channel is classified as active or inactive depending on whether a number is active (or not) on the prescribed OTT network. In an example, active numbers are considered to be active if they have received a message and read it. Based on OTT capabilities it is possible to report on “read messages”. If a user does not read a message within a defined timeframe the number can be deemed “inactive” on that OTT network in question. If a number becomes “inactive” the system can revert to sending messages via an alternative channel, which can be an alternative OTT channel or an SMS channel for example.

If a number becomes inactive an enterprise can configure when and/or if they would like to try to contact that number again via the same OTT network or others. This provides a re-activation retry opt in, and can be instigated by sending a message for the number that seeks to determine if a user is interested in using the particular channel for receipt of messages. This process can rely on a passive or active opt in—for example, active would require a user to perform a task, such as replying, in order to opt in, with no reply resulting in a continuation of the inactive status. Alternatively, a user may have to perform a task, such as replying, in order not to opt in, with no reply resulting in an active status.

A message can be sent via another OTT network or service if the preferred one becomes inactive. For example, if an enterprise specifies according to a set of preferences for a number that a message is preferably to be sent via a first OTT network, but that network has been marked as inactive, a second OTT network can be used.

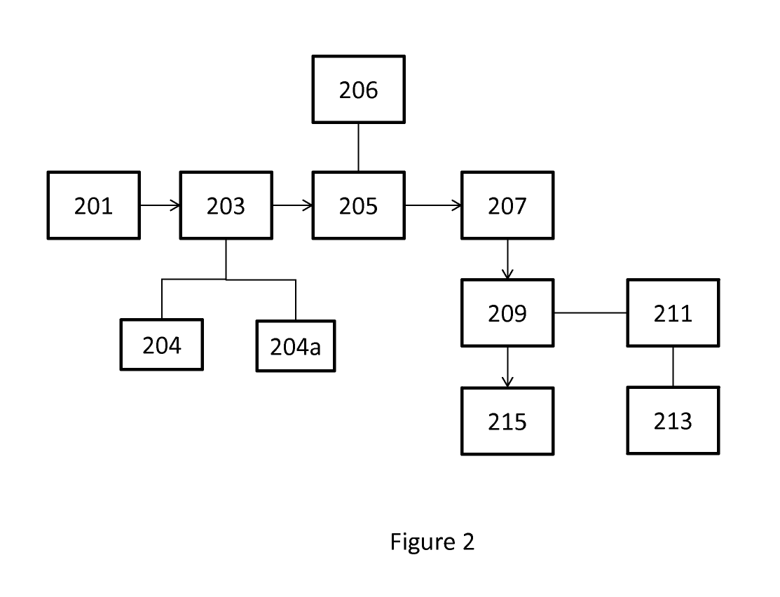

FIG. 2 is a flowchart of a method according to an example. At block 201 an enterprise (or individual and so on) provides a message package in block 203 to be routed. The message can be composed of data 204 representing information to be relayed to a user of a device 213. In addition the message package can include a listing of recipients 204a for the message data 204. In an example the list of recipients is provided as a set of identifiers that are linked to multiple users, such as their phone numbers for example. This means that message data intended for relay to and consumption by a user can be independent of the device that a user is using since such things can and typically so change over time.

In block 205, the message package 203 is received at a messaging application server 206. In an example, server 206 provides, as far as enterprise 201 is concerned, a cloud-based repository and processing device to receive message package 203 and process the data associated with the package in order to route the message 204 to one or more recipients using a preselected or other appropriate method. The message data 204 can be routed or otherwise forwarded or sent as an SMS or MMS message for example, or as a message sent using an OTT service or application. The selection of a delivery channel can be based on the message content and/or on a set of preferences associated with the enterprise and/or the recipients of the message. For example, an enterprise may have a unilateral preference for any message to be sent using an OTT service or application and to not send a message if this is not possible, such as because a recipient does not have an active OTT service or application associated with them.

Alternatively, data 205 for recipients can include preference data for multiple (or all) recipients that specifies a desired delivery mechanism, and/or a set of delivery mechanism alternatives in the case of failure or inability to send a message using an initial preference for example.

According to an example, server 206 is operatively coupled to enable forwarding, routing or sending of messages using multiple delivery channels 207. For example, server 206 can have access to a telecommunication network infrastructure in order to enable the routing of messages for sending over the network in question. In addition, server 206 can be connected to the internet in order to enable to send data packets for an OTT network application or service.

At block 209 a delivery channel for recipient is selected according to the preferences 211 associated with device 213 (or more particularly the identifier associated with the recipient) and the sender 201's routing preferences. At block 215, a message is routed, sent or otherwise forwarded to the recipient using the selected delivery mechanism or channel.

In an example, data representing a read receipt can be received from the recipient device at the application server after it has received the message and provided such a receipt (for example, if a user permits this to be sent unless it is sent automatically). On the basis of the read receipt, the preferences associated with the device can be updated. For example, receipt at the server of receipt data can indicate that the device/user is active at the destination to which the message was sent, and preferences can be updated as appropriate to indicate that the recipient is active on a particular delivery channel. Preferences can further include determining an elapsed period of time between forwarding of the message and receipt of the read receipt. A relatively long period of time can indicate that the user is active but is likely less inclined to be receptive to messages received on the delivery channel in question due to the time taken to view the message. Conversely, a relatively short period of time can indicate that a user is active and receptive.

In some cases, a recipient may not have an active data connection because, for example, the device has no WiFi signal, is abroad with data roaming disabled, is outside of 3G, 4G or GPRS coverage, of a network etc. In such case, preferences associated with the sender 201 may indicate an alternative mechanism for the sending of a message, such as by SMS for example. In some instances, the preferences may preclude a message being sent if it cannot be sent using an OTT network service or application.

In an example, messaging application server 104, 206 can be implemented in a computer system including a processor, memory, non-volatile storage, and an interface for example. Peripheral devices can also be considered part of the computer system. A typical computer system will include at least a processor, memory, and a device (e.g., a bus) coupling the memory to the processor. The processor can include, for example, a general-purpose central processing unit (CPU), such as a microprocessor, or a special-purpose processor, such as a microcontroller. The memory can include, by way of example but not limitation, random access memory (RAM), such as dynamic RAM (DRAM) and static RAM (SRAM). The memory can be local, remote, or distributed. The term “computer-readable storage medium” is intended to include physical media, such as memory.

The bus can couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

A processor is considered to be “configured to execute a program” when at least one value associated with the program is stored in a register readable by the processor. The bus can also couple the processor to one or more interfaces. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device.

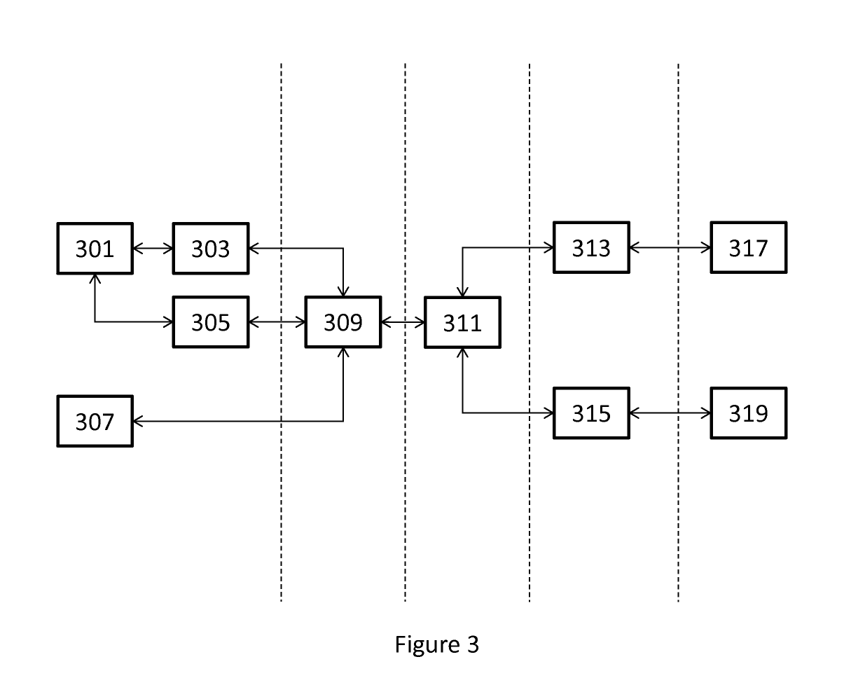

FIG. 3 is a schematic block diagram of an overview of a system according to an example. A user 301 can interact with the system via an enterprise product at block 303 or using a desktop application in block 305. For example, a plug-in can be provided that can enable a user 301 to leverage the system of the present invention from within an existing application. A web user 307 can also use the system, and all are connected to the internet in block 309. Accordingly, interactions can be made with a platform of the system in block 311. For example, a messaging campaign can be set up in which a target set of numbers to message is generated based on an initial set that has been filtered using a template. Within the messaging platform a message can be forwarded for sending using multiple carriers. A message can be sent using XMPP (Extensible Messaging and Presence Protocol) for example in block 313 to recipients 317. Alternatively, a message can be sent in block 315 to recipients 319 using SMPP (Short Message Peer-to-Peer) for example as described above. Other alternatives are possible as will be appreciated.

1. A computer-implemented method for routing a message to a recipient user equipment device, comprising:
receiving data representing the message at a messaging application server;
selecting a delivery channel for the message from multiple delivery channels on the basis of a set of delivery preferences associated with the recipient device; and
forwarding the message using the selected delivery channel.

2. A method as claimed in claim 1, wherein selecting a delivery channel includes determining a notional cost to deliver the message using respective ones of the multiple delivery channels.

3. A method as claimed in claim 1, wherein a delivery channel is selected from one of an SMS delivery channel for a telecommunication network and a data channel.

4. A method as claimed in claim 3, wherein a data channel is selected in preference to an SMS delivery channel.

5. A method as claimed in claim 1, further comprising:
receiving a read receipt from the recipient device at the application server for a forwarded message over a data channel;
updating the preferences associated with the device on the basis of the received receipt.

6. A method as claimed in claim 5, wherein updating the preferences includes determining an elapsed period of time between forwarding of the message and receipt of the read receipt.

7. A method as claimed in claim 1, wherein a message is forwarded over the selected delivery channel using the extensible messaging and presence protocol (XMPP).

8. A method as claimed in claim 1, wherein determining the identity of the device includes using metadata associated with the message to determine a contact number for the device.

9. A method as claimed in claim 1, wherein the set of preferences is mapped to the identity of the device.

10. A method as claimed in claim 9, wherein the identity of a device is determined using metadata from a message received at the application server from the recipient device.

11. A method as claimed in claim 10, further including:
augmenting a device database stored on the application server with details of the device including at least an identifier associated with the device.

12. A method as claimed in claim 1, wherein the message is forwarded to multiple recipient user equipment devices.

13. A system for routing a message to a recipient user equipment device, comprising:
a messaging application server to:
receive data representing the message;
select a delivery channel for the message from multiple available delivery channels on the basis of a set of delivery preferences associated with the device; and
forward the message using the selected delivery channel.

14. A system as claimed in claim 13, wherein the application server is operable to select a delivery channel based, at least in part, on a notional cost associated with forwarding the message using respective ones of the multiple delivery channels.

15. A system as claimed in claim 13, wherein the application server is operable to receive a read receipt from the recipient device for a forwarded message over a data channel; and
classify a delivery channel for the device on the basis of the received receipt.

16. A system as claimed in claim 13, wherein the application server is operable to use metadata associated with a message received by it from a device to determine an identifier for the device.

17. A system as claimed in claim 16, wherein the application server is operable to use the metadata to determine if the device is a known device, and if not to augment a device database stored on the application server with details of the device including at least an identifier associated with the device.

18. A computer program product, comprising a computer usable medium having computer readable program code embodied therein, said computer readable program code adapted to be executed to implement a method for routing a message to a recipient user equipment device as claimed in claim 1.
